(19) United States
(12) Patent Application Publication
(10) Pub. No.: US 2013/0173141 A1
(43) Pub. Date: Jul. 4, 2013

(54) ACCELERATION SHOCK REDUCTION CONTROL DEVICE, AND METHOD AND PROGRAM PRODUCT FOR CONTROLLING ACCELERATION SHOCK REDUCTION

(71) Applicant: Suzuki Motor Corporation, Hamamatsu-shi (JP)

(72) Inventors: Masahiro Hamamura, Hamamatsu-shi (JP); Kazunori Kawai, Hamamatsu-shi (JP)

(73) Assignee: SUZUKI MOTOR CORPORATION, Hamamatsu-shi (JP)

(21) Appl. No.: 13/729,385

(22) Filed: Dec. 28, 2012

(30) Foreign Application Priority Data
Dec. 28, 2011 (JP) 2011-289592

(51) Int. Cl. F02D 35/00

(52) U.S. Cl. CPC F02D 35/00
USPC 701/110

(57) ABSTRACT

An acceleration shock reduction control device, which reduces an acceleration shock occurring when a vehicle shifts from a deceleration state to an acceleration state, includes a first detector that detects rotation information of an engine mounted on the vehicle, a second detector that detects rotation information of a driving wheel which rotates by an output transmitted from the engine, and a controller that performs control to reduce the acceleration shock based on deviation information between the rotation information detected by the first detector and the rotation information detected by the second detector.

### CROSS-REFERENCE TO RELATED APPLICATIONS

This application is based upon and claims the benefit of priority of the prior Japanese Patent Application No. 2011-289592, filed on Dec. 28, 2011, the entire contents of which are incorporated herein by reference.

### BACKGROUND OF THE INVENTION

1. Field of the Invention

The present invention relates to an acceleration shock reduction control device, and a method and a program product for controlling acceleration shock reduction. The present invention is suitably used to reduce an acceleration shock occurring when a vehicle shifts from a deceleration state to an acceleration state.

2. Description of the Related Art

When a vehicle such as a motorcycle shifts from a deceleration state to an acceleration state, a driver sometimes receives an acceleration shock when slightly opening a throttle. The acceleration shock is ascribable to an allowance existing between power transmission members provided between a driving source and a driving wheel of the vehicle. Specifically, in the deceleration state, the aforesaid allowance exists on one side between the power transmission members, but when the vehicle shifts to the acceleration state, the allowance moves to the other side between the power transmission members, so that the power transmission members come into strong contact with each other.

In order to reduce such an acceleration shock, Patent Document 1, for example, discloses an acceleration shock reduction control device including a controlling unit which, upon determining a shift from a deceleration state to an acceleration state, adjusts an output by controlling ignition of an internal combustion engine. Concretely, when a deviation between a rotation speed of a crankshaft and a rotation speed of a counter shaft reaches a predetermined threshold value, it is determined that a predetermined waiting time has passed, and an ignition cut is instructed over a predetermined ignition cycles.
[Patent Document 1] Japanese Laid-open Patent Publication No. 2008-190332

However, the calculation of the deviation between the rotation speed of the crankshaft and the rotation speed of the counter shaft in the acceleration shock reduction control device of Patent Document 1 has a problem that no consideration is given to an acceleration shock ascribable to an allowance of power transmission members on subsequent stages of the counter shaft, such as, for example, a drive chain, a sprocket, and so on. Specifically, even though the acceleration shock due to the power transmission members on the subsequent stages of the counter shaft is large, the control to reduce the acceleration shock may not work if an acceleration shock due to power transmission members on preceding stages of the counter shaft is small.

Further, in the case where the ignition cut is instructed upon the determination that the predetermined waiting time has passed when the deviation between the rotation speed of the crankshaft and the rotation speed of the counter shaft reaches the predetermined threshold value, as in the acceleration shock reduction control device of Patent Document 1, there is a problem that an ignition cut timing is delayed. The delay in the ignition cut timing involves a risk that an inertia force of the crankshaft is generated and even the ignition cut cannot reduce the acceleration shock sufficiently.

### SUMMARY OF THE INVENTION

The present invention was made in consideration of the above-described problems and has an object to accurately determine a case where an acceleration shock occurs to sufficiently reduce the acceleration shock.

An acceleration shock reduction control device according to the present invention is an acceleration shock reduction control device which reduces an acceleration shock occurring when a vehicle shifts from a deceleration state to an acceleration state, the acceleration shock reduction control device including: means for detecting rotation information of an engine mounted on the vehicle; means for detecting rotation information of a driving wheel which rotates by an output transmitted from the engine; and means for performing control to reduce the acceleration shock based on deviation information between the rotation information detected by the means for detecting rotation information of the engine and the rotation information detected by the means for detecting rotation information of the driving wheel.

Further, an acceleration shock reduction control method according to the present invention is an acceleration shock reduction control method which reduces an acceleration shock occurring when a vehicle shifts from a deceleration state to an acceleration state, the method including: an engine rotation information detecting step of detecting rotation information of an engine mounted on the vehicle; a driving wheel rotation information detecting step of detecting rotation information of a driving wheel which rotates by an output transmitted from the engine; and a reduction controlling step of performing control to reduce the acceleration shock based on deviation information between the rotation information detected by the engine rotation information detecting step and the rotation information detected by the driving wheel rotation information detecting step.

A program product according to the present invention is a program product for controlling an acceleration shock reduction control device which reduces an acceleration shock occurring when a vehicle shifts from a deceleration state to an acceleration state, the program product causing a computer to execute: an engine rotation information detecting step of detecting rotation information of an engine mounted on the vehicle; a driving wheel rotation information detecting step of detecting rotation information of a driving wheel which rotates by an output transmitted from the engine; and a reduction controlling step of performing control to reduce the acceleration shock based on deviation information between the rotation information detected by the engine rotation information detecting step and the rotation information detected by the driving wheel rotation information detecting step.

### BRIEF DESCRIPTION OF THE DRAWINGS

FIG. 1 is a view showing a whole structure of a motorcycle.

FIG. 2 is a schematic view showing a route where an output of an engine is transmitted to a rear wheel.

FIG. 3 is a diagram showing a structure of an acceleration shock reduction control device.

FIG. 4 is a chart showing a change of an engine rotation speed.

FIG. 5 is a chart showing a change of a rotation difference value.

FIG. 6 is a chart showing a change of an increase rate of the engine rotation speed.

FIG. 7 is a chart showing a change of a throttle opening degree.

FIG. 8 is a chart showing a map of threshold values of a throttle opening degree according to the engine rotation speed.

FIG. 9 is a chart showing a change of an ignition timing under reduction control.

FIG. 10 is a chart showing a hunting behavior of the engine rotation speed.

FIG. 11 is a flowchart showing an acceleration shock reduction control process.

### DETAILED DESCRIPTION OF THE PREFERRED EMBODIMENTS

Hereinafter, an embodiment according to the present invention will be described with reference to the drawings. An acceleration shock reduction control device according to this embodiment is effectively applicable to various kinds of engines mounted on a vehicle such as a motorcycle. In this embodiment, a case where the acceleration shock reduction control device is applied to a motorcycle will be described.

First, a whole structure of a motorcycle 100 of this embodiment will be described.

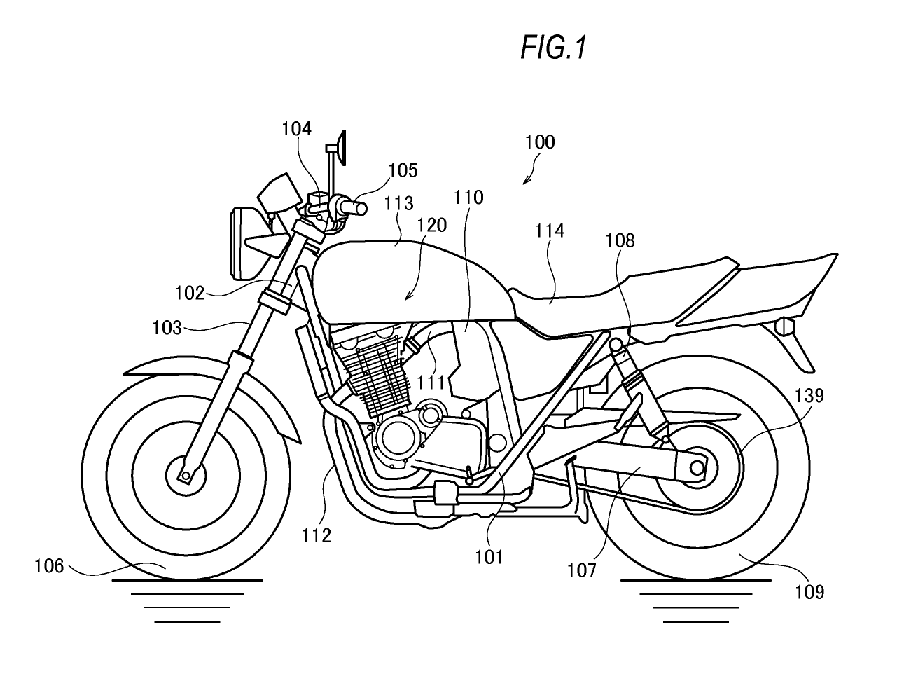

In FIG. 1, two front forks 103 supported by a steering head pipe 102 to be pivotable left and right are provided on a front portion of a body frame 101. A handlebar 104 is fixed to upper ends of the front forks 103, and grips 105 are provided on both ends of the handlebar 104. One of the grips 105 on the both ends is a throttle grip that a driver operates in order to open/close a later-described throttle valve 129. A front wheel 106 is rotatably supported on lower portions of the front forks 103.

A swing arm 107 is swingably provided on a rear portion of the body frame 101, and a rear shock absorber 108 is suspended between the body frame 101 and the swing arm 107. A rear wheel 109 as a driving wheel is rotatably supported on a rear end of the swing arm 107.

An air-fuel mixture is supplied to an engine 120 mounted on the body frame 101 via an intake pipe 111 coupled to an air cleaner 110, and exhaust gas resulting from combustion is discharged through an exhaust pipe 112. Further, a fuel tank 113 is mounted above the engine 120, and a seat 114 is provided at the back of the fuel tank 113.

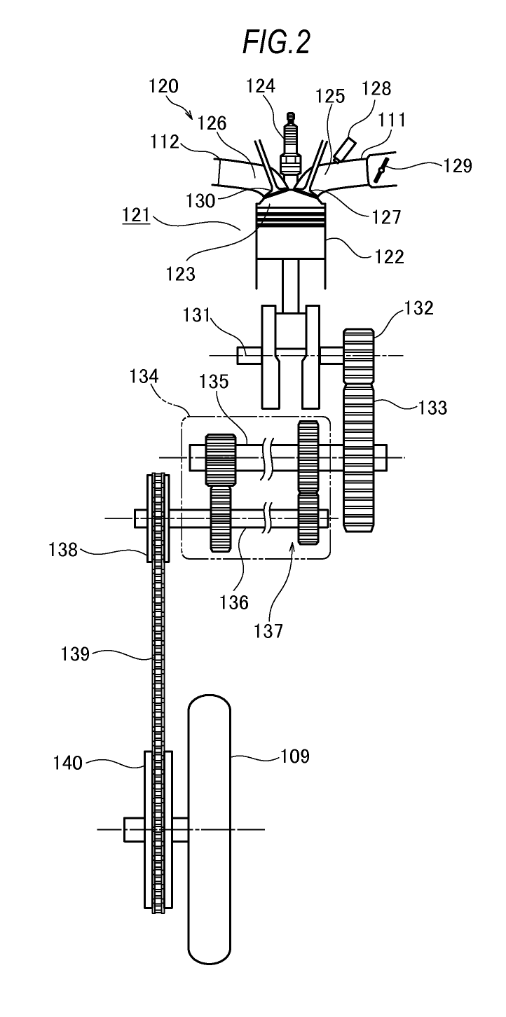

FIG. 2 is a schematic view showing a route where an output of the engine 120 is transmitted to the rear wheel 109.

A piston 122 is reciprocatably disposed in a cylinder assembly 121 included in the engine 120. A combustion chamber 123 is formed on a top portion of the piston 122, and an ignition plug 124 is fixed to the combustion chamber 123, with its tip directed to a center of the combustion chamber 123. Further, in the cylinder assembly 121, an intake port 125 and an exhaust port 126 which communicate with the combustion chamber 123 are formed.

The aforesaid intake pipe 111 is connected to the intake port 125. In the intake port 125, an intake valve 127 which opens/closes so as to allow the supply of the air-fuel mixture to the combustion chamber 123 is formed. Further, upstream of the intake port 125, an injector 128 which injects a fuel to intake air supplied from the intake pipe 111 is disposed. Further, in the middle of the intake pipe 111, the throttle valve 129 which opens/closes according to the operation of the aforesaid throttle grip is disposed. According to a throttle opening degree by which the throttle valve 129 is pivoted, an amount of the intake air supplied to the engine 120 through the intake pipe 111 increases/decreases.

The aforesaid exhaust pipe 112 is connected to the exhaust port 126. In the exhaust port 126, an exhaust valve 130 which opens/closes so as to allow the discharge of the exhaust gas from the combustion chamber 123 is disposed.

The air-fuel mixture supplied into the combustion chamber 123 is ignited by the ignition plug 124 to be burned, and then is discharged as the exhaust gas via the exhaust pipe 112. When the air-fuel mixture is burned, the piston 122 performs the reciprocating motion. The reciprocating motion of the piston 122 is converted to rotation of the crankshaft 131.

The rotation of the crankshaft 131 is input to a transmission 134 via a primary drive gear 132 and a primary drive gear 133. The transmission 134 includes a main shaft 135, a counter shaft 136, and a plurality of transmission gears 137. The rotation input from the main shaft 135 is converted with a necessary reduction ratio by the transmission gears 137 and thereafter is output from the counter shaft 136.

A drive sprocket 138 is pivotally fitted to the counter shaft 136. The drive sprocket 138 is connected to a driven sprocket 140 via a drive chain 139. The driven sprocket 140 is coupled to the rear wheel 109. Therefore, the rotation from the counter shaft 136 is transmitted to the rear wheel 109 via the drive sprocket 138, the drive chain 139, and the driven sprocket 140, so that the motorcycle 100 is driven.

In the motorcycle 100 thus structured, an acceleration shock occurring at the time of a shift from a deceleration state to an acceleration state occurs due to an allowance between the power transmission members provided between the engine 120 and the rear wheel 109. Here, the power transmission members include the aforesaid primary drive gear 132, primary driven gear 133, transmission 134, drive sprocket 138, drive chain 139, driven sprocket 140, and so on.

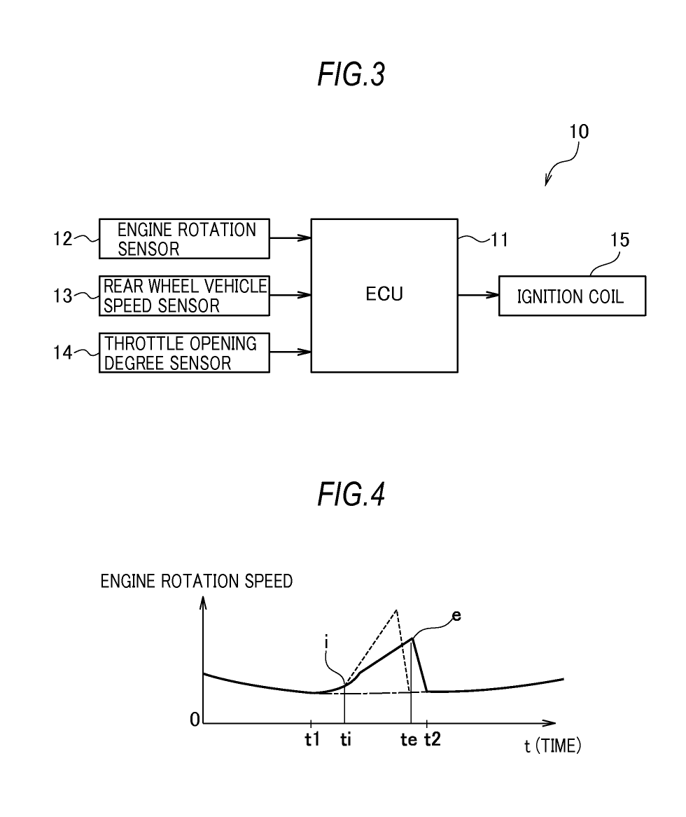

Next, a structure of the acceleration shock reduction control device 10 which performs control to reduce the acceleration shock (hereinafter, referred to as reduction control) will be described with reference to FIG. 3. FIG. 3 is a block diagram showing the structure of the acceleration shock reduction control device 10.

The acceleration shock reduction control device 10 includes an ECU 11, an engine rotation sensor 12, a rear wheel vehicle speed sensor 13, a throttle opening degree sensor 14, an ignition coil 15, and so on.

The ECU 11 is an electronic control unit which functions as a computer controlling various kinds of constituent devices and is disposed, for example, under the seat 114. The ECU 11 corresponds to an example of means for performing control to reduce the acceleration shock or the like. The ECU 11 includes a CPU, a memory, an input interface, an output interface, and so on. By the CPU executing a program stored in the memory, the ECU 11 determines whether or not the acceleration shock occurs, based on signals output from various kinds of sensors or the like, and when the acceleration shock occurs, performs the control to reduce the output of the engine 120. Further, in the ECU 11, threshold values used in determining whether or not the acceleration shock occurs, a map, and so on are stored in the memory.

The engine rotation sensor 12 detects a rotation speed of the crankshaft 131 as rotation information of the engine 120 and is disposed near the crankshaft 131. The engine rotation sensor 12 corresponds to an example of means for detecting rotation information of the engine. The engine rotation sensor 12 outputs the detected rotation speed of the crankshaft 131 to the ECU 11.

The rear wheel vehicle speed sensor 13 detects a rotation speed of the rear wheel 109 as rotation information of the driving wheel and is disposed near the rear wheel 109. The rear wheel vehicle speed sensor 13 corresponds to an example of means for detecting rotation information of the driving wheel. The rear wheel vehicle speed sensor 13 outputs the detected rotation speed of the rear wheel 109 to the ECU 11.

The throttle opening degree sensor 14 detects a throttle opening degree of the throttle valve 129 and is disposed near the throttle valve 129. The throttle valve opening degree sensor 14 corresponds to an example of means for detecting the throttle opening degree. The throttle opening degree sensor 14 outputs a signal corresponding to the throttle opening degree of the throttle valve 129 to the ECU 11.

The ignition coil 15 supplies a high-voltage current to the ignition plug 124 at a timing as instructed by the ECU 11. Therefore, in the combustion chamber 123 of the engine 120, the ignition plug 124 is ignited at the timing instructed by the ECU 11 and the combustion takes place.

As described above, the acceleration shock occurring when the motorcycle 100 shifts from the deceleration state to the acceleration state is ascribable to the allowance between the power transmission members provided between the engine 120 and the rear wheel 109. Therefore, in this embodiment, in order to accurately determine the acceleration shock, the occurrence of the acceleration shock is determined based on deviation information between the engine rotation speed detected by the engine rotation sensor 12 and the rear wheel rotation speed detected by the rear wheel vehicle speed sensor 13.

Incidentally, since, from the engine 120 up to the rear wheel 109, the speed is reduced by the power transmission members such as the transmission 134, it is not preferable to compare the engine rotation speed and the rear wheel rotation speed as they are. Therefore, the ECU 11 converts the rear wheel rotation speed detected by the rear wheel vehicle speed sensor 13 to an engine rotation speed by using an expression (1) and an expression (2). Hereinafter, the rotation speed being the engine rotation speed to which the rear wheel rotation speed is converted will be called a rear wheel vehicle speed-engine rotation speed.

rear wheel vehicle speed−engine rotation speed=rear wheel rotation speed/vehicle speed calibration value×calibrated engine rotation speed expression (1)

Note that the “rear wheel rotation speed” in the expression (1) is a moving average deviation of the rear wheel rotation speed detected by the rear wheel vehicle speed sensor 13, and an average value of the latest ten rear wheel rotation speeds, for example, is adopted.

Further, the “vehicle speed calibration value” can be calculated from the expression (2).

$$vehicle speed calibration value = \frac{\begin{matrix}0.06 \times n \times calibrated engine rotation speed \times \\ number of drive sprocket \times rear wheel diameter\end{matrix}}{gear ratio \times number of teeth of driven sprocket} \qquad expression ( 2 )$$

FIG. 4 is a chart showing a change of the engine rotation speed. The broken line represents the engine rotation speed when the acceleration shock occurs, without the reduction control being performed. The solid line represents the engine rotation speed when the acceleration shock is reduced, with the reduction control being performed. Further, the dashed line represents the rear wheel vehicle speed-engine rotation speed being the engine rotation speed to which the rear wheel rotation speed is converted. In FIG. 4, it is seen that the reduction control is performed from a time ti to a time te. Further, portions not illustrated, of the engine rotation speed represented by the broken line and the rear wheel vehicle speed-engine rotation speed represented by the dashed line overlap with the engine rotation speed represented by the solid line and the depiction thereof is omitted.

In FIG. 4, the deceleration state is before a time t1 and the acceleration state is after the time t1. Before the time t1, the engine rotation speed and the rear wheel vehicle speed-engine rotation speed present the same change. On the other hand, after the shift from the deceleration state to the acceleration state at the time t1, the engine rotation speed increases while the allowance between the power transmission members moves from one side to the other side. After the time ti, a gradient of the engine rotation speed represented by the solid line when the reduction control is performed is less than that of the engine rotation speed represented by the broken line when the reduction control is not performed. Thereafter, the allowance between the power transmission members completely moves from the one side to the other side, and from a time t2 when the power transmission members come into contact with each other again, the engine rotation speed and the rear wheel vehicle speed-engine rotation speed present the same change again. The larger the deviation between the engine rotation speed and the rear wheel vehicle speed-engine rotation speed is, the more distinctly the acceleration shock appears in the vehicle behavior when the power transmission members come into contact with each other again.

Therefore, in this embodiment, the ECU 11 performs the reduction control when the engine rotation speed changes as shown by the broken line in FIG. 4 and the acceleration shock occurs, thereby reducing the engine rotation speed as shown by the solid line in FIG. 4. Concretely, by using, as the deviation information, a rotation difference value equal to the engine rotation speed from which the rear wheel vehicle speed-engine rotation speed is subtracted, the ECU 11 performs the control to make the rotation difference value small.

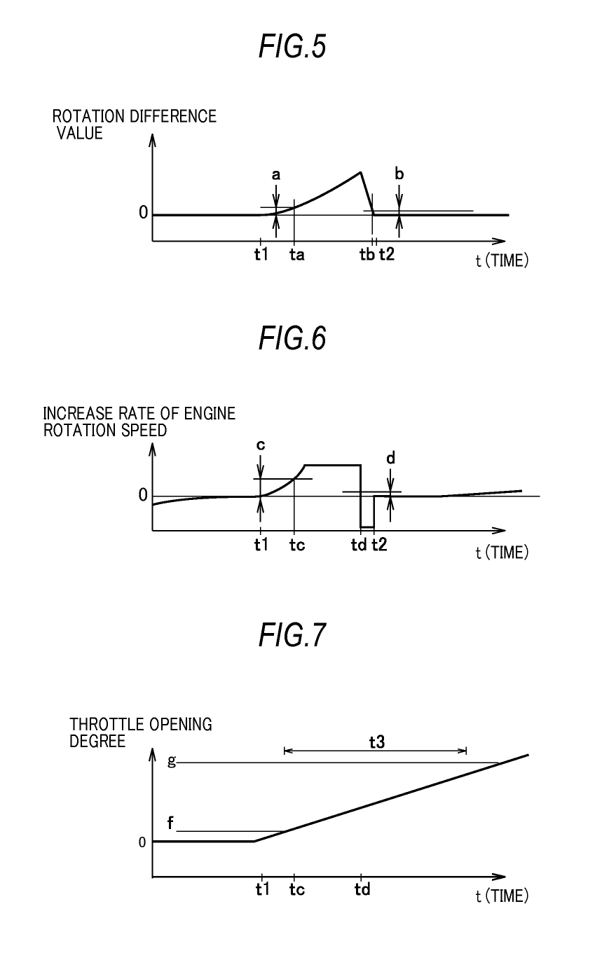

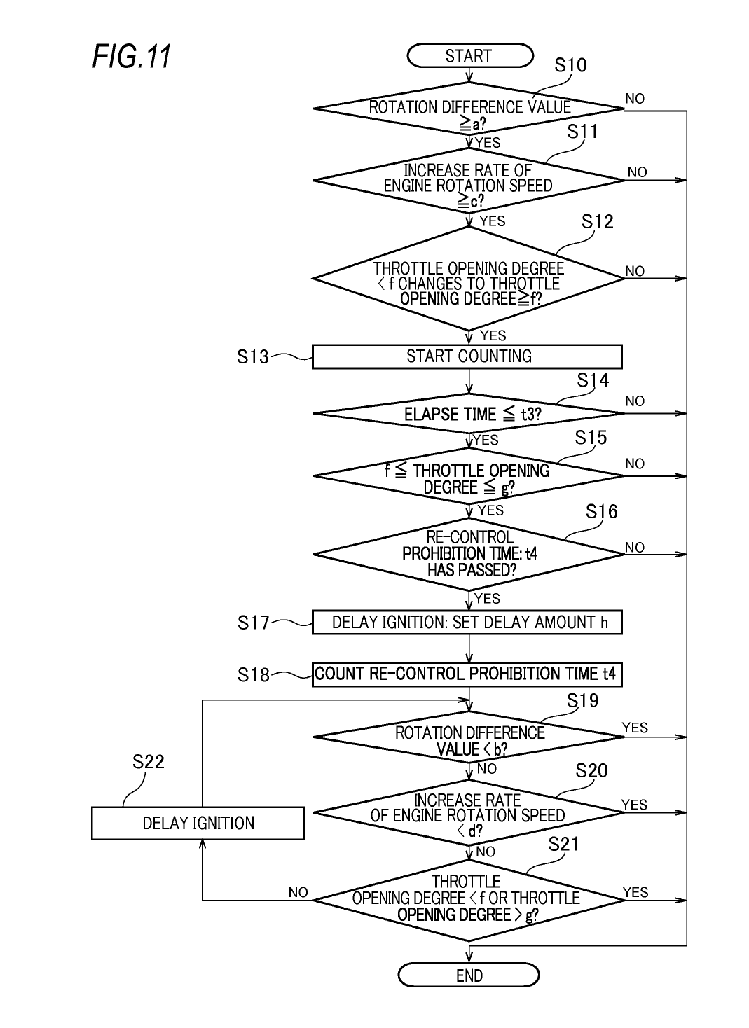

Hereinafter, the reduction control according to this embodiment will be concretely described with reference to the flowchart shown in FIG. 11 and the graphs shown in FIG. 5 to FIG. 10. Note that the flowchart shown in FIG. 11 is realized by the CPU of the ECU 11 executing the program stored in the memory, and is constantly executed by the CPU. The ECU 11 constantly obtains the engine rotation speed, the rear wheel rotation speed, and the throttle opening degree from the engine rotation sensor 12, the rear wheel vehicle speed sensor 13, and the throttle opening degree sensor 14, and stores them including those in a past predetermined time.

First, at Step S10, the ECU 11 calculates the rear wheel vehicle speed-engine rotation speed from the rear wheel rotation speed by using the aforesaid expressions (1) and (2). Next, the ECU 11 calculates the rotation difference value by subtracting the rear wheel vehicle speed-engine rotation speed from the engine rotation speed, and determines whether or not the calculated rotation difference value is equal to or more than a threshold value a (first deviation threshold value). When the rotation difference value is equal to or more than the threshold value a, the ECU 11 determines that there is a possibility that the acceleration shock occurs, to go to a process at Step S11. On the other hand, when the rotation difference value is less than the threshold value a, it ends the process.

FIG. 5 is a chart showing a change of the rotation difference value. The change of the rotation difference value shown in FIG. 5 is a result of the subtraction of the rear wheel vehicle speed-engine rotation speed represented by the dashed line from the engine rotation speed represented by the solid line shown in FIG. 4. As shown in FIG. 5, the rotation difference value gradually increases from the time t1 when the shift from the deceleration state to the acceleration state takes place, and it becomes equal to or more than the threshold value a at a time ta. At the time ta when the rotation difference value becomes equal to or more than the threshold value a, the ECU 11 goes to Step S11.

Next, at Step S11, the ECU 11 calculates an increase rate of the engine rotation speed, and determines whether or not the increase rate is equal to or more than a threshold value c (first change rate threshold value). The ECU 11 constantly calculates the increase rate of the engine rotation speed based on the engine rotation speed. When the increase rate is equal to or more than the threshold value c, the ECU 11 determines that there is a possibility that the acceleration shock occurs, to go to a process at Step S12. On the other hand, when the increase rate is less than the threshold value c, it ends the process. A reason why the increase rate of the engine rotation speed is used for the determination of the acceleration shock is that the engine rotation speed rapidly increases when the acceleration shock occurs.

FIG. 6 is a chart showing a change of the increase rate of the engine rotation speed. The change of the increase rate shown in FIG. 6 is an increase rate of the engine rotation speed represented by the solid line in FIG. 4. As shown in FIG. 6, the increase rate is a negative value in the deceleration state before the time t1, increases over 0 (zero) from the time t1, and becomes equal to or more than the threshold value c at a time tc. The ECU 11 goes to Step S12 at the time tc when the increase rate becomes equal to or more than the threshold value c. Incidentally, in the description here, the increase rate of the engine rotation speed is used, but a change rate of the engine rotation speed may be used.

A reason why not only the rotation difference value but also the increase rate of the engine rotation speed is used is to more accurately determine the acceleration shock. Specifically, due to an influence of the vibration of the engine 120, a running surface, and the like, the engine rotation speed is likely to fluctuate. When only one of the rotation difference value and the increase rate of the engine rotation speed is used, a mere vibration is determined as the occurrence of the acceleration shock by mistake and the reduction control is unnecessarily performed, which has an adverse effect on a behavior of the vehicle.

Further, in this embodiment, later-described Step S12 to Step S16 are added for the more accurate determination of the acceleration shock.

Further, the aforesaid threshold value a and threshold value c are preferably as small values as possible. The purpose is to monitor a slight behavior indicating the occurrence of the acceleration shock and when the acceleration shock occurs, to perform the reduction control at an early stage before the engine rotation speed becomes high. When the threshold value a and the threshold value c are large, the start timing of the reduction control is delayed, so that the engine rotation speed becomes high and an inertia force is generated, which makes it difficult to sufficiently reduce the acceleration shock.

Next, at Step S12, the ECU 11 determines whether or not the throttle opening degree changes from a throttle opening degree less than a predetermined throttle opening degree f to become equal to or more than the predetermined opening degree f. When this condition is satisfied, the ECU 11 goes to a process at Step S13, and when the condition is not satisfied, it ends the process.

FIG. 7 is a chart showing a change of the throttle opening degree. As shown in FIG. 7, the throttle opening degree is 0 (zero) in the deceleration state before the time t1 and gradually increases from the vicinity of the time t1. In FIG. 7, the predetermined throttle opening degree f being a lower limit at which the acceleration shock occurs and a later-described throttle opening degree g being an upper limit at which the acceleration shock occurs are shown.

Here, at the time tc when the increase rate is determined as being equal to or more than the threshold value c at Step S11, the throttle opening degree has already changed from the throttle opening degree less than the predetermined throttle opening degree f to become equal to or more than the predetermined opening degree f, and therefore, the ECU 11 goes to a process at Step S13.

Note that the predetermined throttle opening degree f and the predetermined throttle opening degree g are set according to the engine rotation speed, taking a change of running resistance into consideration.

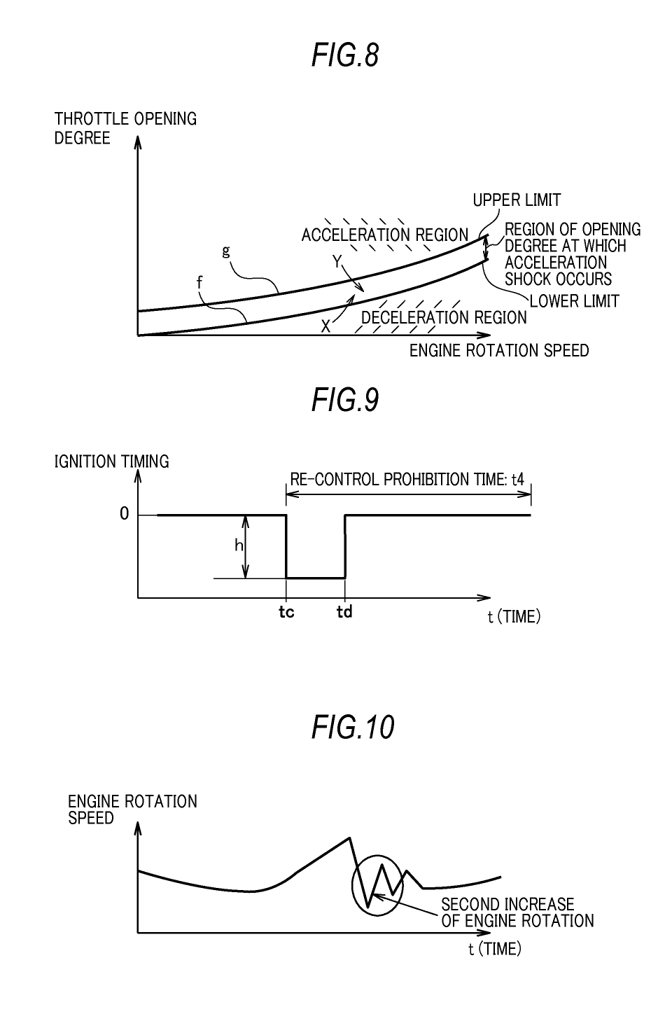

FIG. 8 is a chart showing a map of the threshold values of the throttle opening degree according to the engine rotation speed. As shown in FIG. 8, the predetermined throttle opening degree f and the predetermined throttle opening degree g gradually increase in accordance with an increase of the engine rotation speed. A region between a curve representing the predetermined throttle opening degree f and a curve representing the predetermined throttle opening degree g is a region of the throttle opening degree at which the acceleration shock occurs. Further, a region under the curve representing the predetermined throttle opening degree f is a deceleration region, and a region above the curve representing the predetermined throttle opening degree g is an acceleration region.

The arrow X shown in FIG. 8 represents an example where the throttle opening degree changes from a throttle opening degree less than the predetermined throttle opening degree f to become equal to or more than the predetermined throttle opening degree f and shifts to the region of the opening degree at which the acceleration shock occurs. On the other hand, the arrow Y represents an example where the throttle opening degree changes from a throttle opening degree larger than the predetermined throttle opening degree g to become equal to or less than the predetermined throttle opening degree g and shifts to the region of the opening degree at which the acceleration shock occurs.

Here, the acceleration shock has a characteristic of occurring when the throttle opening degree changes from the deceleration region to the acceleration region as represented by the arrow X. Therefore, at Step S12, with attention being focused on this characteristic, the case of the shift as represented by the arrow Y is excluded, and a process narrowing down target cases to the case of the shift represented by the arrow X is performed.

Next, at Step S13, the ECU 11 starts counting when the throttle opening degree becomes equal to or more than the predetermined throttle opening degree f at Step S12.

At Step S14, the ECU 11 determines whether or not an elapse time from the start of the counting at Step S13 is a predetermined time t3 or less. When the elapse time is equal to or less than the predetermined time t3, there is a possibility that the acceleration shock occurs, and therefore the ECU 11 goes to a process at Step S15, and when the elapse time is more than the predetermined time t3, it ends the process. In FIG. 7, the time t3 counted from the instant when the throttle opening degree becomes equal to or more than the throttle opening degree f is shown. Here, a reason why it is determined whether or not the predetermined time t3 has passed is that the acceleration shock usually occurs only within the predetermined time t3 after the throttle opening degree becomes equal to or more than the predetermined throttle opening degree f, and does not occur when more than the predetermined time t3 passes. Therefore, by the processes at Step S13 and Step S14, it is possible to narrow down the target cases only to the case where the acceleration shock occurs.

Next, at Step S15, the ECU 11 determined whether or not the throttle opening degree is not less than the predetermined throttle opening degree f nor more than the predetermined throttle opening degree g. When the throttle opening degree is within this predetermined range, the ECU 11 goes to a process at Step S16, and when the throttle opening degree is not within this predetermined range, it ends the process. As for the predetermined throttle opening degree f and the predetermined throttle opening degree g used for the determination, the aforesaid map, shown in FIG. 8, of the threshold values of the throttle opening degree according to the engine rotation speed is used. Such a process enables the narrowing down only to the case where the acceleration shock occurs.

Next, at Step S16, the ECU 11 determines whether or not a re-control prohibition time t4 has passed. Here, the re-control prohibition time is a time that the ECU 11 sets at later-described Step S18, and will be described in more detail at Step S18. When the re-control prohibition time t4 has passed, the ECU 11 goes to a process at Step S17, and when the re-control prohibition time t4 has not passed, it ends the process.

Next, at Step S17, the ECU 11 starts the reduction control. Concretely, the ECU 11 instructs the ignition coil 15 to supply the high-voltage current at a timing to which the ignition timing of the ignition plug 124 is delayed.

FIG. 9 is a chart showing a change of the ignition timing under the reduction control. In FIG. 9, the ignition timing less than 0 (zero) indicates the delay, and here, a distance from the ignition timing 0 (zero) is represented as a delay amount h. As shown in FIG. 9, the delay amount is 0 (zero) in a period up the time tc when the aforesaid determinations of Steps S10 to S16 are satisfied, and the delay amount h is set from the time tc.

Incidentally, the ECU 11 sets the delay amount corresponding to the engine rotation speed and the throttle opening degree, according to a map of the delay amount corresponding to the engine rotation speed and the throttle opening degree.

Such reduction control makes it possible to make an increase gradient of the engine rotation speed from the time ti small, as is shown by the engine rotation speed represented by the solid line in FIG. 4, compared with the engine rotation speed represented by the broken line when the reduction control is not performed. Therefore, it is possible to reduce the rotation difference value between the engine rotation speed and the rear wheel vehicle speed-engine rotation speed, enabling a reduction of the acceleration shock.

Next, at Step S18, the ECU 11 starts counting the re-control prohibition time t4. Concretely, as shown in FIG. 9, the ECU 11 counts the re-control prohibition time t4 from the instant when the reduction control is started at Step S17. The re-control prohibition time is a time during which the re-start of the reduction control is prohibited. That is, when the elapse time up to the aforesaid Step S16 is within the re-control prohibition time t4 set at Step S18 in the reduction control up to the previous one, the reduction control is not performed but the process is ended.

A reason why the re-control prohibition time t4 is thus set is to prevent a hunting behavior of the engine rotation speed that occurs due to too large a decrease of the engine rotation speed when the finish timing of the reduction control is delayed.

FIG. 10 is a chart showing the hunting behavior of the engine rotation speed. When the finish timing of the reduction control is delayed and the decrease of the engine rotation speed is too large, a second increase of the engine rotation speed occurs as shown in FIG. 10. At this time, if the re-control prohibition time is not set, the ECU 11 performs the reduction control in response to the second increase of the engine rotation speed. Therefore, the increase of the engine rotation speed and the reduction control are repeated, which appears as the hunting behavior.

Therefore, because the re-control prohibition time is set, it is possible to end the process by the determination at Step S16 without performing the reduction control, when the elapse time is within the re-control prohibition time, even if an attempt is made to perform the reduction control again in response to the increase of the engine rotation speed at and after the second time.

Next, at Step S19, the ECU 11 determines whether or not the calculated rotation difference value is less than a threshold value b (second deviation threshold value). When the rotation difference value is less than the threshold value b, the ECU 11 cancels the delay amount h of the ignition timing set at Step S17 and ends the reduction control. On the other hand, when the rotation difference value is equal to or more than the threshold value b, the ECU 11 goes to a process at Step S20.

As shown in FIG. 5, the rotation difference value rapidly decreases by the reduction control and becomes less than the threshold value b at a time tb. The ECU 11 cancels the set delay amount at the time tb when the rotation difference value becomes less than the threshold value b, and ends the reduction control. Note that the threshold value b is set smaller than the threshold value a. Therefore, it is possible to prevent a phenomenon that the rotation difference value reaches the threshold value b immediately after becoming equal to or more than the threshold value a from the aforesaid Step 10 and the reduction control cannot be sufficiently performed.

At Step S20, the ECU 11 determines whether or not the increase rate of the engine rotation speed is less than a threshold value d (second change rate threshold value). When the increase rate is less than the threshold value d, the ECU 11 cancels the delay amount h of the ignition timing set at Step S17, and ends the reduction control. On the other hand, when the increase rate is equal to or more than the threshold value d, the ECU 11 goes to a process at Step S21.

As shown in FIG. 6, the increase rate becomes a negative value immediately at a time td by the reduction control, and at this time, becomes less than the threshold value d. The ECU 11 cancels the set delay amount at the time td when the increase rate becomes less than the threshold value d, and ends the reduction control. Note that the threshold value d is set smaller than the threshold value c. Therefore, it is possible to prevent a phenomenon that the increase rate reaches the threshold value d immediately after becoming equal to or more than the threshold value c from the aforesaid Step S11 and the reduction control cannot be sufficiently performed.

At Step S21, the ECU 11 determines whether or not the throttle opening degree is less than the predetermined throttle opening degree f or is larger than the predetermined throttle opening degree g. When the throttle opening degree is within this range, the ECU 11 cancels the delay amount h of the ignition timing set at Step S17, and ends the reduction control. On the other hand, when the throttle opening degree is not within this range, the ECU 11 goes to a process at Step S22. As for the predetermined throttle opening degree f and the predetermined throttle opening degree g used for this determination, the aforesaid map, shown in FIG. 8, of the threshold values of the throttle opening degree according to the engine rotation speed is used.

At Step S22, the ECU 11 continues to set the delay amount h of the ignition timing and continues to perform the reduction control. Thereafter, until the reduction control is ended, the processes at Step S19 to Step S22 are repeated.

Generally, when the change of the engine rotation speed is reversed from an increase to a decrease (point e shown in FIG. 4), the increase rate of the engine rotation speed immediately becomes less than the aforesaid threshold value d (time td shown in FIG. 6). Therefore, the delay amount of the ignition timing returns to a normal one at the time td as shown in FIG. 9, and the reduction control is ended. Thus ending the reduction control at the timing when the engine rotation speed stops increasing makes it possible to prevent a decrease of the engine rotation speed from becoming too large and prevent the hunting behavior shown in FIG. 10.

As described above, according to this embodiment, the deviation information between the rotation information detected by the engine rotation sensor 12 and the rotation information detected by the rear wheel vehicle speed sensor 13 is used to determine the acceleration shock, which makes it possible to improve the determination accuracy, since the acceleration shock occurs due to the deviation between the rotation speeds of the engine 120 and the rear wheel 109.

Further, according to this embodiment, in addition to the deviation information, the change rate of the rotation information detected by the engine rotation sensor 12 and the throttle opening degree detected by the throttle opening degree sensor 14 are used to accurately determine the acceleration shock. Therefore, it is possible to perform the reduction control only when the acceleration shock actually occurs, which can prevent the reduction control from being performed unnecessarily.

Further, according to this embodiment, the reduction control is performed only within the predetermined time after the throttle opening degree detected by the throttle opening degree sensor 14 changes from a throttle opening degree less than the predetermined throttle opening degree to become equal to or more than the predetermined throttle opening degree. Since the acceleration shock occurs only in this predetermined time, it is possible to prevent the reduction control from being unnecessarily performed in a period not falling within this predetermined time.

Further, according to this embodiment, since the re-control prohibition time is set from the start of the reduction control, it is possible to prevent the reduction control from being performed in response to the increase of the engine rotation speed at or after the second time, which can prevent the hunting behavior of the engine rotation speed.

Further, according to this embodiment, the acceleration shock is reduced by delaying the ignition timing, which enables the easier control of a reduction amount of the engine output, compared with, for example, the ignition cut. Further, since the combustion in the engine 120 takes place even when the ignition timing is delayed, components of the exhaust gas are the same as those of the exhaust gas burned without the delay, and therefore, this embodiment is excellent also in view of protecting a catalyst.

In the forgoing, the present invention is described based on the above embodiment, but the present invention is not limited only to the above embodiment, and changes and so on can be made within the range of the present invention.

For example, in the above embodiment, the case where the present invention is applied to the motorcycle is described, but the present invention is applicable not only to this case but also to other vehicles in which the acceleration shock occurs at the time of the shift from the deceleration state to the acceleration state due to an allowance of power transmission members provided between an engine and a driving wheel.

Further, in the above embodiment, the case where the rotation difference value equal to the engine rotation speed from which the rear wheel vehicle speed-engine rotation speed is subtracted is taken as an example in the description, but this case is not restrictive. That is, it is only necessary that the deviation information between the engine rotation information and the driving wheel rotation information is used for the determination.

Further, in this embodiment, the case where the process of the flowchart shown in FIG. 11 is realized by the CPU of the ECU 11 executing the program is described, but this case is not restrictive, and the process of the flowchart shown in FIG. 11 may be executed by circuits structured as hardware.

It should be noted that the above embodiments merely illustrate concrete examples of implementing the present invention, and the technical scope of the present invention is not to be construed in a restrictive manner by these embodiments. That is, the present invention may be implemented in various forms without departing from the technical spirit or main features thereof.

According to the present invention, it is possible to accurately determine a case where an acceleration shock occurs and sufficiently reduce the acceleration shock.

What is claimed is:

1. An acceleration shock reduction control device which reduces an acceleration shock occurring when a vehicle shifts from a deceleration state to an acceleration state, the acceleration shock reduction control device comprising:
means for detecting rotation information of an engine mounted on the vehicle;
means for detecting rotation information of a driving wheel which rotates by an output transmitted from the engine; and
means for performing control to reduce the acceleration shock based on deviation information between the rotation information detected by the means for detecting rotation information of the engine and the rotation information detected by the means for detecting rotation information of the driving wheel.

2. The acceleration shock reduction control device according to claim 1, further comprising
means for calculating rotation information which converts the rotation information detected by the means for detecting rotation information of the driving wheel to rotation information of the engine to calculate the rotation information,
wherein the deviation information is a rotation difference value between the rotation information detected by the means for detecting rotation information of the engine and the rotation information calculated by the means for calculating rotation information.

3. The acceleration shock reduction control device according to claim 1, further comprising
means for calculating a change rate which calculates the change rate of engine rotation information based on the rotation information detected by the means for detecting rotation information of the engine,
wherein the means for performing control to reduce the acceleration shock performs the control to reduce the acceleration shock based on the change rate calculated by the means for calculating the change rate.

4. The acceleration shock reduction control device according to claim 3, wherein:
the means for performing control to reduce the acceleration shock starts the control to reduce the acceleration shock when it is satisfied that the deviation information is equal to or more than a first deviation threshold value and the change rate of engine rotation information is equal to or more than a first change rate threshold value; and
the means for performing control to reduce the acceleration shock ends the control to reduce the acceleration shock when the deviation information becomes less than a second deviation threshold value or the change rate of engine rotation information becomes less than a second change rate threshold value, after the control to reduce the acceleration shock is started.

5. The acceleration shock reduction control device according to claim 1, further comprising
means for detecting a throttle opening degree which detects the throttle opening degree of a throttle valve,
wherein the means for performing control to reduce the acceleration shock performs the control to reduce the acceleration shock based on the throttle opening degree detected by the means for detecting the throttle opening degree.

6. The acceleration shock reduction control device according to claim 5, wherein the means for performing control to reduce the acceleration shock performs the control to reduce the acceleration shock when the throttle opening degree detected by the means for detecting the throttle opening degree is within a predetermined range set according to an engine rotation speed.

7. The acceleration shock reduction control device according to claim 5, wherein the means for performing control to reduce the acceleration shock performs the control to reduce the acceleration shock when the throttle opening degree detected by the means for detecting the throttle opening degree changes from a throttle opening degree less than a predetermined throttle opening degree to become equal to more than the predetermined throttle opening degree.

8. The acceleration shock reduction control device according to claim 7, wherein the means for performing control to reduce the acceleration shock performs the control to reduce the acceleration shock only within a predetermined time after the throttle opening degree becomes equal to or more than the predetermined throttle opening degree.

9. The acceleration shock reduction control device according to claim 1, wherein, in a predetermined time after the control to reduce the acceleration shock is started, the means for performing control to reduce the acceleration shock prohibits the control to reduce the acceleration shock again after ending the control to reduce the acceleration shock.

10. The acceleration shock reduction control device according to claim 1, wherein the means for performing control to reduce the acceleration shock reduces the acceleration shock by delaying an ignition timing of the engine.

11. The acceleration shock reduction control device according to claim 10, wherein a delay amount by which the ignition timing of the engine is delayed is set according to the engine rotation information and a throttle opening degree.

12. An acceleration shock reduction control method which reduces an acceleration shock occurring when a vehicle shifts from a deceleration state to an acceleration state, the method comprising:
an engine rotation information detecting step of detecting rotation information of an engine mounted on the vehicle;
a driving wheel rotation information detecting step of detecting rotation information of a driving wheel which rotates by an output transmitted from the engine; and
a reduction controlling step of performing control to reduce the acceleration shock based on deviation information between the rotation information detected by the engine rotation information detecting step and the rotation information detected by the driving wheel rotation information detecting step.

13. A program product for controlling an acceleration shock reduction control device which reduces an acceleration shock occurring when a vehicle shifts from a deceleration state to an acceleration state, the program product causing a computer to execute:
an engine rotation information detecting step of detecting rotation information of an engine mounted on the vehicle;
a driving wheel rotation information detecting step of detecting rotation information of a driving wheel which rotates by an output transmitted from the engine; and
a reduction controlling step of performing control to reduce the acceleration shock based on deviation information between the rotation information detected by the engine rotation information detecting step and the rotation information detected by the driving wheel rotation information detecting step.

14. An acceleration shock reduction control device which reduces an acceleration shock occurring when a vehicle shifts from a deceleration state to an acceleration state, the acceleration shock reduction control device comprising:
a first detector that detects rotation information of an engine mounted on the vehicle;
a second detector that detects rotation information of a driving wheel which rotates by an output transmitted from the engine; and
a controller that performs control to reduce the acceleration shock based on deviation information between the rotation information detected by the first detector and the rotation information detected by the second detector.
